(19) United States
(12) Patent Application Publication
(10) Pub. No.: US 2026/0196877 A1
(43) Pub. Date: Jul. 9, 2026

(54) WIRELESS CHARGING PILLOW WITH INTEGRATED POWER BANK

(71) Applicant: Belkin International, Inc., El Segundo, CA (US)

(72) Inventors: Oliver Seil, Long Beach, CA (US); Aaron Sevier, Corona Del Mar, CA (US); Mitchell Suckle, Long Beach, CA (US); Senka Bergman, Montara, CA (US)

(73) Assignee: Belkin International, Inc., El Segundo, CA (US)

(21) Appl. No.: 19/441,426

(22) Filed: Jan. 6, 2026

Related U.S. Application Data
(60) Provisional application No. 63/742,101, filed on Jan. 6, 2025.

(51) Int. Cl. H02J 50/10; A47G 9/10; H02J 7/70; H02J 50/90

(52) U.S. Cl. CPC H02J 50/10; A47G 9/1045; H02J 7/731; H02J 50/90

(57) ABSTRACT

A wireless charging pillow including a pillow body. The wireless charging pillow also can include a wireless charging pad located at a surface of the pillow body. The wireless charging pillow additionally can include a power bank located within the pillow body. The wireless charging pillow further can include an electrical connection between the wireless charging pad and the power bank. Other embodiments are described.

### CROSS-REFERENCE TO RELATED APPLICATION

This application claims the benefit of U.S. Provisional Application No. 63/742,101, filed Jan. 6, 2025. U.S. Provisional Application No. 63/742,101 is incorporated herein by reference in its entirety.

### TECHNICAL FIELD

This disclosure relates generally to a wireless charging pillow with an integrated power bank.

### BACKGROUND

Wireless charging technology has become increasingly popular in recent years, offering users a convenient way to power their electronic devices without the need for traditional wired connections. This technology typically utilizes electromagnetic fields to transfer energy between a charging pad and a compatible device, such as a smartphone or tablet. Concurrently, the use of portable power banks has become widespread, allowing users to charge their devices on-the-go without access to a wall outlet. These power banks typically contain rechargeable batteries and can provide multiple charges to electronic devices before being recharged themselves.

### BRIEF DESCRIPTION OF THE DRAWINGS

To facilitate further description of the embodiments, the following drawings are provided in which:

FIG. 1 illustrates a schematic view of a wireless charging pillow, according to an embodiment;

FIG. 2 illustrates a top side perspective view of a wireless charging pillow, according to an embodiment;

FIG. 3 illustrates a top plan view of the wireless charging pillow of FIG. 2;

FIG. 4 illustrates a top perspective view of wireless charging pillow of FIG. 2 while the wireless charging pillow is charging an electronic device;

FIG. 5 illustrates a top plan view of the wireless charging pillow of FIG. 2 while the wireless charging pillow is charging the electronic device of FIG. 4;

FIG. 6 illustrates a top perspective view of the wireless charging pillow of FIG. 2 while the wireless charging pillow is charging the electronic device of FIG. 4;

FIG. 7 illustrates a side elevation view of the wireless charging pillow of FIG. 2 while the wireless charging pillow is charging the electronic device of FIG. 4;

FIG. 8 illustrates a side perspective view of a wireless charging pillow that is being unzipped using a zipper to access a pocket, according to an embodiment;

FIG. 9 shows a side perspective view of the wireless charging pillow of FIG. 8, in which a power bank is partially inserted in the pocket of FIG. 8, showing how the power bank can be inserted and/or removed from the wireless charging pillow of FIG. 8;

FIG. 10 shows a side perspective view of the wireless charging pillow of FIG. 8, in which the power bank of FIG. 9 is fully inserted and seated within the pocket of FIG. 8;

FIG. 11 shows a side perspective view of the wireless charging pillow of FIG. 8 after the pocket of FIG. 8 is partially closed, but allowing the charging cable of FIG. 9 to extend, to allow the power bank of FIG. 9 to be charged using the charging cable;

FIG. 12 illustrates a perspective view of the wireless charging pillow of FIG. 8 being used on a sofa, with a wireless charging pad of the wireless charging pillow facing outward away from the sofa;

FIG. 13 illustrates a perspective view of the wireless charging pillow of FIG. 8 on the sofa of FIG. 12 while the electronic device of FIG. 4 is coupled to the wireless charging pad of FIG. 12;

FIG. 14 illustrates a perspective view of the wireless charging pillow of FIG. 8 on a counter while charging the electronic device of FIG. 4;

FIG. 15 illustrates a perspective view of the wireless charging pillow of FIG. 8 on a lap of a child;

FIG. 16 illustrates a perspective view of the wireless charging pillow of FIG. 8 on the lap of another child; and

FIG. 17 illustrates a flowchart for an embodiment of a method of providing a wireless charging pillow, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable. “Mechanical coupling” and the like should be broadly understood and include mechanical coupling of all types.

The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

Various embodiments include a wireless charging pillow including a pillow body. The wireless charging pillow also can include a wireless charging pad located at a surface of the pillow body. The wireless charging pillow additionally can include a power bank located within the pillow body. The wireless charging pillow further can include an electrical connection between the wireless charging pad and the power bank.

Some embodiments include a method of providing a wireless charging pillow. The method can include providing a pillow body. The method also can include providing a wireless charging pad located at a surface of the pillow body. The method additionally can include providing a power bank located within the pillow body. The method further can include providing an electrical connection between the wireless charging pad and the power bank.

Despite the convenience offered by both wireless charging and portable power banks, users often face challenges in finding comfortable and practical ways to utilize these technologies, particularly in relaxed settings such as living rooms. Traditional charging solutions may require users to leave their devices in specific locations or positions, which can be inconvenient or disruptive to their normal routines. Furthermore, the combination of wireless charging capabilities with portable power sources in a single, user-friendly product has remained a relatively unexplored area. Such a combination can offer users greater flexibility and convenience in charging their devices across various scenarios and locations. As electronic devices continue to play an increasingly central role in daily life, there is an ongoing need for innovative charging solutions that seamlessly integrate into users'environments and routines while providing both convenience and functionality.

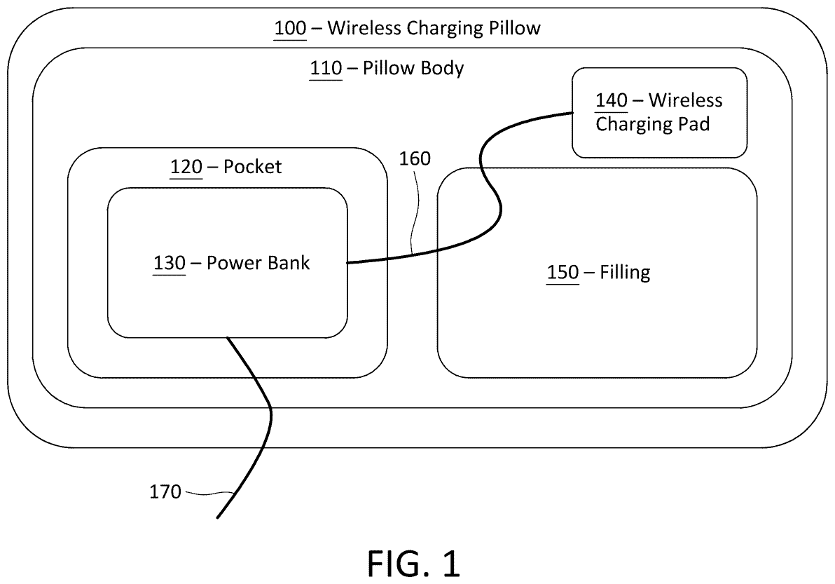

Turning to the drawings, FIG. 1 illustrates a schematic view of a wireless charging pillow 100. Wireless charging pillow 100 is merely exemplary, and embodiments of the wireless charging pillow are not limited to the embodiments presented herein. The wireless charging pillow can be employed in many different embodiments or examples not specifically depicted or described herein. In many embodiments, wireless charging pillow 100 can include a pillow body 110, a pocket 120, a power bank 130, a wireless charging pad 140, filling 150, a connection cable 160, and/or a charging cable 170. In many embodiments, pillow body 110 can form the outer structure of wireless charging pillow 100. Wireless charging pad 140 can be located at a surface of pillow body 110. Wireless charging pad 140 can be positioned to allow for convenient charging of electronic devices placed on the surface of pillow body 110. Power bank 130 can be located within pillow body 110, such as within pocket 120 within pillow body 110. Power bank 130 can serve as an energy storage device to power wireless charging pad 140. Connection cable 160 can electrically connect wireless charging pad 140 and power bank 130. Connection cable 160 can allow for the transfer of electrical energy from power bank 130 to wireless charging pad 140.

In many embodiments, pillow body 110 can form the outer structure of wireless charging pillow 100. In some cases, pillow body 110 may be sized and shaped for use on a sofa, couch, reclining chair, or other suitable object. Pillow body 110 can have various shapes and sizes to accommodate different user preferences and/or furniture configurations. Pillow body 110 can be composed of a soft, flexible material such as fabric, cotton, polyester, or a blend of materials. In some cases, pillow body 110 may include venting features to prevent overheating of power bank 130. These venting features can include small perforations or mesh sections in the material of pillow body 110 to allow for air circulation, or the use of heat-absorbing materials to assist in prevention of heat-related concerns in some electronic devices. In some implementations, pillow body 110 can have a rectangular shape, while in other implementations, pillow body 110 can have a circular, square, or irregular shape. The size of pillow body 110 can vary from small decorative pillow dimensions to larger body pillow dimensions. Pillow body 110 can include a zippered opening to allow access to the internal components of wireless charging pillow 100. In some cases, pillow body 110 can have reinforced sections to support the weight of various electronic devices placed on wireless charging pillow 100 for charging.

In many embodiments, pillow body 110 can include pocket 120. Pocket 120 can be located within pillow body 110, as shown in FIG. 1. Pocket 120 can serve as a housing for power bank 130. In some implementations, pocket 120 can be a zippered, or closed with hook-and-loop tape, snaps, buttons, or other fasteners, which can allow for easy access to power bank 130. Pocket 120 can include a soft, flexible material such as fabric, cotton, polyester, or a blend of materials. In some cases, pocket can include venting features to prevent overheating of power bank 130. These venting features can include small perforations or mesh sections in the material of pocket 120 to allow for air circulation.

In many embodiments, wireless charging pillow 100 can include filling 150 within pillow body 110. Filling 150 can occupy the interior space of pillow body 110 around pocket 120. Filling 150 can be configured to conform to various different surfaces, providing comfort and adaptability to wireless charging pillow 100. Filling 150 can include various materials. In some cases, filling 150 can include batting or stuffing. These materials can provide a soft and plush feel to wireless charging pillow 100. In other cases, filling 150 can include bean-bag pellets. The bean-bag pellets can allow wireless charging pillow 100 to readily conform to different shapes and surfaces, enhancing its versatility. The composition and arrangement of filling 150 can contribute to the overall functionality of wireless charging pillow 100. For example, filling 150 can be distributed in a manner that allows wireless charging pillow 100 to maintain a desired shape while still being flexible enough to adapt to different surfaces or user positions. This adaptability can enhance the user experience by allowing comfortable placement of wireless charging pillow 100 in various settings, such as on a sofa, bed, or other furniture.

In some implementations, filling 150 can include a thermally conductive material. The thermally conductive material can help dissipate heat generated during the charging process (e.g., charging power bank 130 or charging the electronic device from power bank 130), improving the efficiency and safety of wireless charging pillow 100. The thermally conductive material can be incorporated into filling 150 in various forms, such as fibers, particles, or a combination thereof. In some cases, the thermally conductive material can include one or more of graphite fibers or particles, aluminum or copper particles, phase change materials (PCMs), ceramic particles with high thermal conductivity, such as boron nitride or aluminum nitride, thermally conductive polymers or gels, and/or other filling materials to enhance overall heat dissipation. These materials can be used individually or in combination with traditional filling materials to improve the thermal management of wireless charging pillow 100 while maintaining comfort and flexibility.

In many embodiments, power bank 130 can be positioned within pocket 120 of pillow body 110, as shown in FIG. 1. In many embodiments, power bank 130 can be removable from pocket 120, which can allow for removal for charging, and/or replacement or upgrading of power bank 130, if desired. This arrangement can allow for removal and replacement of power bank 130, if needed, while keeping it securely housed within pillow body 110 during normal use of wireless charging pillow 100. Power bank 130 can have sufficient charging capacity to provide one or more recharges to an electronic device. In some cases, the capacity can be at least approximately 10,000 mAh (milliamp-hours), which can allow for multiple recharges of an electronic device between recharges of power bank 130 itself.

Power bank 130 can be connected to charging cable 170, which can allow power bank 130 to be charged from an external power source, such as a power adapter plugged into an AC (alternating current) outlet, when pocket 120 is opened. In some cases, charging cable 170 can be a built-in cable that is fixedly coupled to power bank 130. For example, as described above, in some cases, pocket 120 can be a zippered pocket, and the built-in cable (e.g., charging cable 170) can be accessed when the zipper is opened. In other embodiments, charging cable 170 can be removably connected to power bank 130. For example, charging cable 170 can be a USB-C cable or another suitable cable. In some cases, pocket 120 can contain charging cable 170, which in many embodiments can be longer than connection cable 160. This longer cable can be tucked inside pocket 120 when not in use. The longer cable can provide additional flexibility for charging power bank 130. Charging cable 170 can be used to recharge power bank 130 when power bank 130 is depleted. Charging cable 170 can be accessible to a user through pocket 120. Charging cable 170 may be of sufficient length to extend outside of pocket 120, allowing the user to connect charging cable 170 to an external power source, such as a wall outlet or a USB port on a computer. When not in use, charging cable 170 may be tucked back into pocket 120, maintaining a neat appearance of wireless charging pillow 100. Charging cable 170 can allow wireless charging pillow 100 to be recharged without removing power bank 130 from pillow body 110. This feature can enhance the convenience and usability of wireless charging pillow 100, as the user may not need to remove power bank 130 from wireless charging pillow in order to recharge power bank 130.

Power bank 130 can be electrically connected to wireless charging pad 140 via connection cable 160, as illustrated in FIG. 1. This configuration can allow the power stored in power bank 130 to be transferred to an electronic device placed on wireless charging pad 140. As shown in FIG. 1, connection cable 160 can extend from power bank 130 through filling 150 of pillow body 110 to reach wireless charging pad 140. Connection cable 160 can be a short flexible cable capable of transmitting electrical power from power bank 130 to wireless charging pad 140. In some cases, connection cable 160 can be a USB-C cable or another suitable cable. Connection cable 160 can have a length sufficient to span the distance between power bank 130 and wireless charging pad 140 within pillow body 110. The routing of connection cable 160 through filling 150 can allow for a clean and unobtrusive appearance of wireless charging pillow 100. Connection cable 160 can be entirely concealed within pillow body 110, with its endpoints connected to power bank 130 and wireless charging pad 140. In some cases, connection cable 160 can be secured or anchored at various points within pillow body 110 to prevent shifting or tangling. Connection cable 160 can be designed to withstand the compression and movement typically experienced within a pillow during normal use.

In some embodiments, wireless charging pad 140 can be compatible with Qi2, MagSafe, and/or other suitable wireless charging technologies to provide magnetic assistance to ensure alignment between coils in the electronic device and wireless charging pad 140. Wireless charging pad 140 can be configured to charge various electronic devices, such as a mobile phone or a tablet computer. The positioning of wireless charging pad 140 on the pillow body 110 may vary. In some examples, wireless charging pad 140 can be located on one of the two largest surfaces of wireless charging pillow 100, such as a top surface of wireless charging pillow 100, or another suitable surface. In some examples, wireless charging pad 140 can be centered on the surface or located to one side or one corner of the surface. In some examples, wireless charging pad 140 can protrude out somewhat (e.g., less than approximately 5 millimeters) from the surface of pillow body 110. In other examples, wireless charging pad 140 can be flush with the surface of pillow body 110. To enhance visibility and/or user experience, wireless charging pad 140 can have a color that is different from the color of the surface of pillow body 110. This color differentiation can allow users to easily locate the charging area on the wireless charging pillow 100.

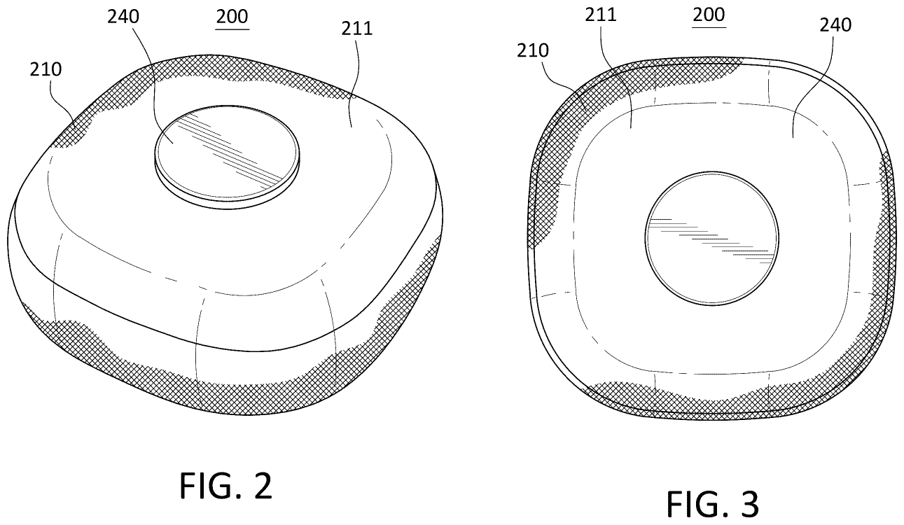

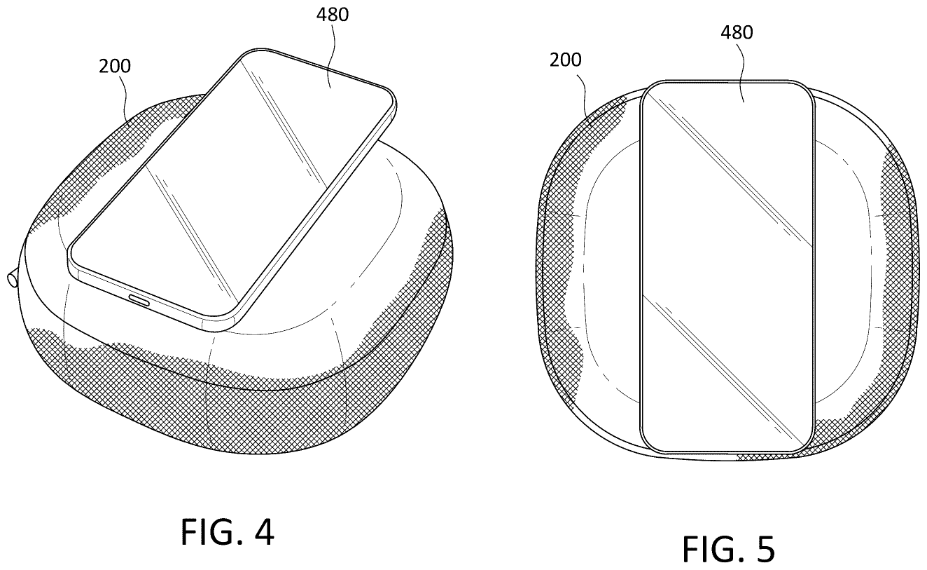

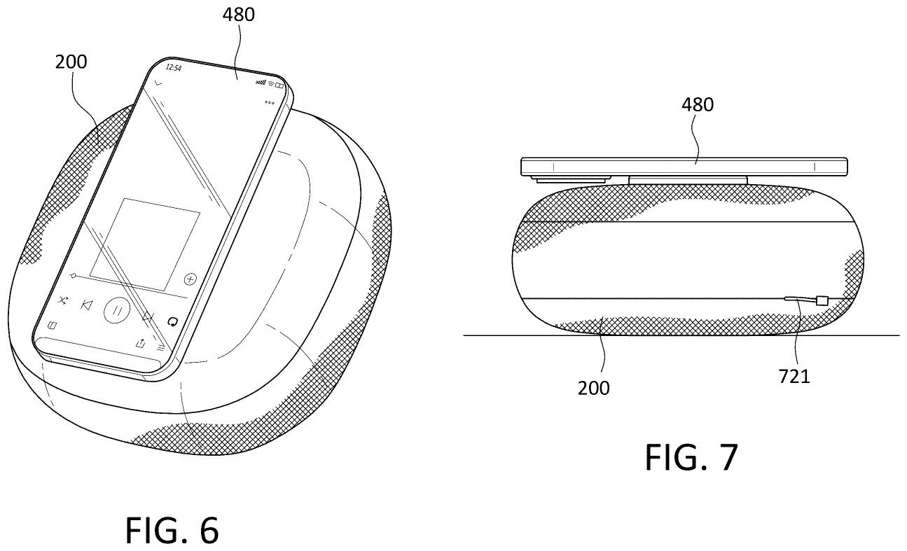

Turning ahead in the drawings, FIG. 2 illustrates a top side perspective view of a wireless charging pillow 200. FIG. 3 illustrates a top plan view of wireless charging pillow 200. FIG. 4 illustrates a top perspective view of wireless charging pillow 200 while wireless charging pillow 200 is charging an electronic device 480. FIG. 5 illustrates a top plan view of wireless charging pillow 200 while wireless charging pillow 200 is charging electronic device 480. FIG. 6 illustrates a top perspective view of wireless charging pillow 200 while wireless charging pillow 200 is charging electronic device 480. FIG. 7 illustrates a side elevation view of wireless charging pillow 200 while wireless charging pillow 200 is charging electronic device 480. Wireless charging pillow 200 is merely exemplary, and embodiments of the wireless charging pillow are not limited to the embodiments presented herein. The wireless charging pillow can be employed in many different embodiments or examples not specifically depicted or described herein.

Wireless charging pillow 200 can be similar or identical to wireless charging pillow 100 (FIG. 1), and various components of wireless charging pillow 200 can be similar or identical to wireless charging pillow 100 (FIG. 1). For example, wireless charging pillow 200 can include various elements, such as a pillow body 210 and a wireless charging pad 140, which can be similar or identical to pillow body 110 (FIG. 1) and wireless charging pad 140 (FIG. 1), respectively. Wireless charging pillow 200 also can include other elements not shown, such as a pocket, a power bank, filling, a connection cable, and/or a charging cord, which can be similar or identical to pocket 120 (FIG. 1), power bank 130 (FIG. 1), filling 150 (FIG. 1), connection cable 160 (FIG. 1), and/or charging cable 170 (FIG. 1), respectively.

As shown in FIGS. 2-3, wireless charging pad 240 can be located in the center of a top surface 211 of pillow body 210 of wireless charging pillow 200. As shown in FIGS. 4-7, electronic device 480 (such as a mobile device/smartphone) can be coupled to wireless charging pad 240, in order to charge electronic device 480. In many embodiments, electronic device 480 can be used by a user while coupled to wireless charging pad 240 of wireless charging pillow 200 to be charged. For example, as shown in FIG. 6, the user can use electronic device 480 while charging to play music and/or access other apps on electronic device 480.

As shown in FIG. 7, wireless charging pillow 200 can include a zipper 721, which can be used to access a pocket (not shown), which can hold the power bank (not shown).

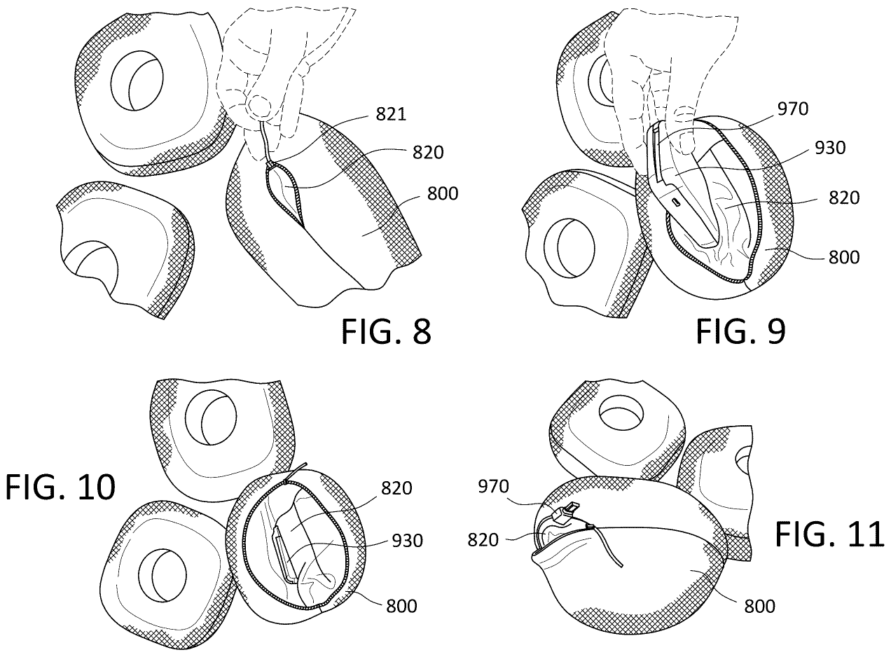

Turning ahead in the drawings, FIG. 8 illustrates a side perspective view of a wireless charging pillow 800 that is being unzipped using a zipper 821 to access a pocket 820. FIG. 9 illustrates a side perspective view of wireless charging pillow 800 as a power bank 930 is inserted in pocket 820. FIG. 10 illustrates a side perspective view of wireless charging pillow 800 with power bank 930 positioned within pocket 820. FIG. 11 illustrates a side perspective view of wireless charging pillow 800 with a charging cable 970 extending out from pocket 820. Wireless charging pillow 800 is merely exemplary, and embodiments of the wireless charging pillow are not limited to the embodiments presented herein. The wireless charging pillow can be employed in many different embodiments or examples not specifically depicted or described herein.

Wireless charging pillow 800 can be similar or identical to wireless charging pillow 100 (FIG. 1) and/or wireless charging pillow 200 (FIG. 2), and various components of wireless charging pillow 800 can be similar or identical to wireless charging pillow 100 (FIG. 1) and/or wireless charging pillow 200 (FIG. 2). FIG. 8 shows how pocket 820 can be accessed by unzipping zipper 821. FIG. 9 shows a side perspective view of wireless charging pillow 800, in which a power bank 930 is partially inserted in pocket 820, showing how power bank 930 can be inserted and/or removed from wireless charging pillow 800, such as when manufacturing wireless charging pillow 800, or when replacing power bank 930. As shown in FIG. 9, power bank 930 includes (built-in) charging cable 970, which is manufactured as part of power bank 930 to allow power bank 930 to be charged using charging cable 970. FIG. 10 shows a side perspective view of wireless charging pillow 800, in which power bank 930 is fully inserted and seated within pocket 820. FIG. 11 shows a side perspective view of wireless charging pillow 800 after pocket 820 is partially closed, but allowing charging cable 970 to extend, to allow power bank 930 to be charged using charging cable 970. As described above, charging cable 970 can be plugged into a suitable power outlet or power port to recharge power bank 930.

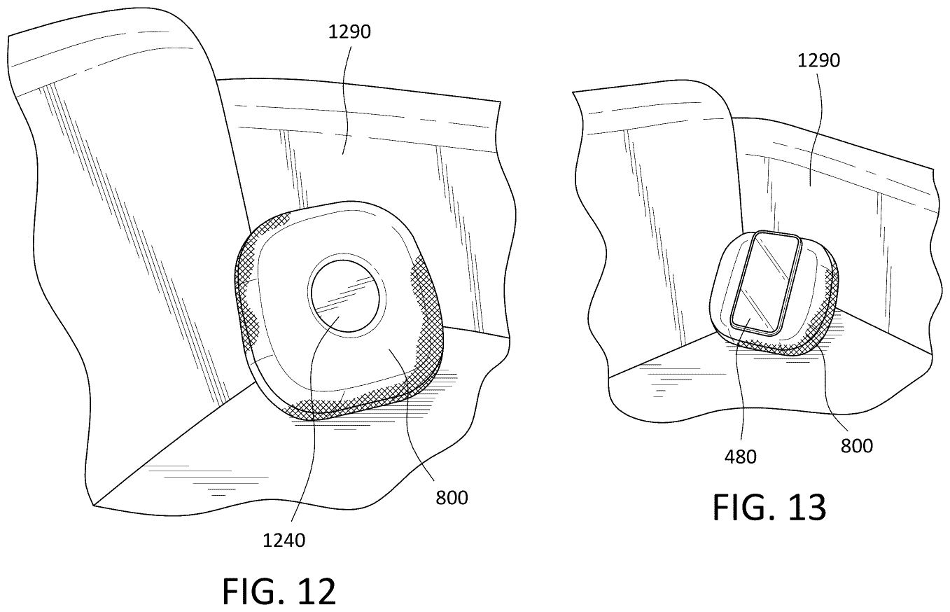

Turning ahead in the drawings, FIG. 12 illustrates a perspective view of an example of wireless charging pillow 800 being used on a sofa 1290, with a wireless charging pad 1240 of wireless charging pillow 800 facing outward away from sofa 1290. FIG. 13 illustrates a perspective view of wireless charging pillow 800 on sofa 1290 while electronic device 480 is coupled to wireless charging pad 1240 (FIG. 12). FIGS. 12-13 illustrate a use case for wireless charging pillow 800 on sofa 1290, to allow users to charge electronic devices (e.g., 480) on sofa 1290 where a charging cable may not be readily available.

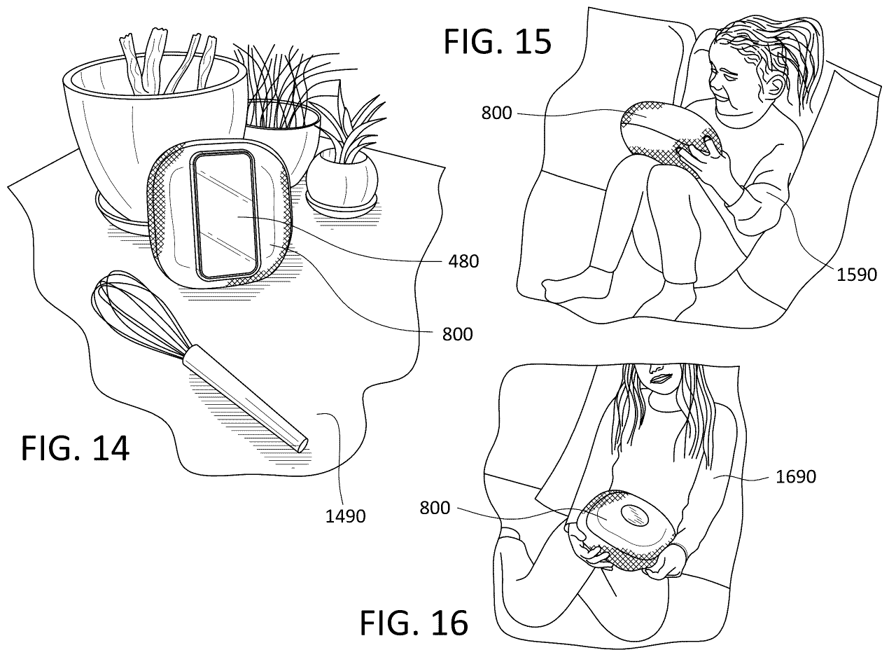

Turning ahead in the drawings, FIG. 14 illustrates a perspective view of an example of wireless charging pillow 800 on a counter 1490 while charging electronic device 480. FIG. 15 illustrates a perspective view of an example of wireless charging pillow 800 on a lap of a child 1590. FIG. 16 illustrates a perspective view of another example of wireless charging pillow 800 on the lap of another child 1690. These examples show that the wireless charging pillow can be used in various different environments and use cases, and the wireless charging pillow can conform to various different surfaces.

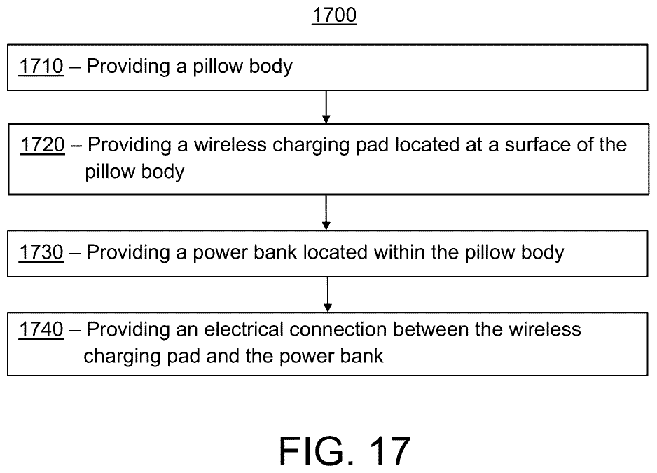

Turning ahead in the drawings, FIG. 17 illustrates a flowchart for an embodiment of a method 1700 of providing a wireless charging pillow, according to another embodiment. Method 1700 is merely exemplary and is not limited to the embodiments presented herein. Method 1700 can be employed in many different embodiments or examples not specifically depicted or described herein. In some embodiments, the procedures, the processes, and/or the activities of method 1700 can be performed in the order presented. In other embodiments, the procedures, the processes, and/or the activities of the method 1700 can be performed in any other suitable order. In still other embodiments, one or more of the procedures, the processes, and/or the activities in method 1700 can be combined or skipped. The wireless charging pillow can be similar or identical to wireless charging pillow 100 (FIG. 1), wireless charging pillow 200 (FIGS. 2-7), and/or wireless charging pillow 800 (FIGS. 8-16).

Referring to FIG. 17, method 1700 can include a block 1710 of providing a pillow body. The pillow body can be similar or identical to pillow body 110 (FIG. 1), and/or pillow body 210 (FIG. 2).

In a number of embodiments, method 1700 also can include a block 1720 of providing a wireless charging pad located at a surface of the pillow body. The wireless charging pad can be similar or identical to wireless charging pad 140 (FIG. 1), wireless charging pad 240 (FIG. 2), and/or wireless charging pad 1240 (FIG. 12).

In several embodiments, method 1700 additionally can include a block 1730 of providing a power bank located within the pillow body. The power bank can be similar or identical to power bank 130 (FIG. 1), and/or power bank 930 (FIG. 9).

In a number of embodiments, method 1700 further can include a block 1740 of providing an electrical connection between the wireless charging pad and the power bank. The electrical connection can be similar or identical to connection cable 160 (FIG. 1).

The wireless charging pillow can be used in various locations and on different surfaces, such as on a sofa or couch, providing a comfortable resting spot for users while charging their devices; in bed, allowing users to charge their devices while relaxing or sleeping; on an armchair or recliner, offering a convenient charging solution during leisure activities; on the floor, serving as a floor cushion with added functionality; in a home office setting, placed on a desk chair for easy device charging during work hours; in a car or RV, used as a travel pillow with charging capabilities during long journeys; on outdoor furniture like patio chairs or loungers, enabling device charging in outdoor living spaces; in waiting areas or lobbies, providing a comfortable seating option with built-in charging for visitors; in libraries or study areas, offering a dual-purpose cushion for comfort and device charging during study sessions; on window seats or reading nooks, enhancing these spaces with charging functionality; in children's play areas, potentially serving as a soft seating option with charging capabilities for tablets or educational devices; in conference rooms or meeting spaces, providing comfortable seating with charging options during long meetings; and/or other suitable places or surfaces. The wireless charging pillow can be designed to conform to various surfaces, allowing it to adapt to different usage scenarios and environments.

Additionally, the wireless charging pillow can be adapted into various alternative designs, such as a seat cushion, which can be used on dining chairs, office chairs, or outdoor seating; a throw pillow or decorative cushion for sofas or beds, potentially blending seamlessly with home decor; a floor cushion or pouf, which may provide comfortable seating with integrated charging capabilities; a lumbar support cushion for office chairs or car seats, offering ergonomic benefits alongside charging functionality; a neck pillow or travel pillow, which may be useful for charging devices during long journeys; a meditation cushion or yoga bolster, combining wellness practices with convenient device charging; a pet bed, which may allow for charging of smart pet devices or owners'devices while providing comfort for pets; an outdoor cushion for patio furniture, which can be weather-resistant for use in various outdoor settings; a reading pillow or backrest, which can support users while reading or working in bed; a wedge pillow, which can offer elevated support for various uses while incorporating charging capabilities; a body pillow, providing full-body support with integrated charging along its length; a stadium seat cushion, offering comfort and charging during sporting events or outdoor gatherings; and/or other suitable designs and/or form factors. These alternative designs can incorporate the same or similar elements as wireless charging pillow 100 (FIG. 1), wireless charging pillow 200 (FIG. 2), and/or wireless charging pillow 800 (FIG. 8), including the wireless charging pad and power bank, while adapting the shape, size, and specific features to suit different use cases and environments.

Although the wireless charging pillow with integrated power bank has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-16 may be modified, and that the foregoing discussion of certain of these embodiments does not necessarily represent a complete description of all possible embodiments. For example, one or more of the elements of FIGS. 1-17 can be swapped with, interchanged, modified, or added to other embodiments described herein.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A wireless charging pillow comprising:
a pillow body;
a wireless charging pad located at a surface of the pillow body;
a power bank located within the pillow body; and
an electrical connection between the wireless charging pad and the power bank.

2. The wireless charging pillow of claim 1, wherein the pillow body comprises a zippered pocket.

3. The wireless charging pillow of claim 2, wherein the power bank is located within the zippered pocket.

4. The wireless charging pillow of claim 3, wherein the power bank comprises a built-in cable accessible to charge the power bank when the zippered pocket is opened.

5. The wireless charging pillow of claim 4, wherein the built-in cable is a USB-C cable.

6. The wireless charging pillow of claim 1, wherein the pillow body comprises a filling material configured to conform to various different surfaces.

7. The wireless charging pillow of claim 6, wherein the filling material comprises bean-bag pellets.

8. The wireless charging pillow of claim 6, wherein the filling material comprises a thermally conductive material.

9. The wireless charging pillow of claim 1, wherein the power bank is configured to provide multiple recharges to an electronic device between recharges of the power bank.

10. The wireless charging pillow of claim 1, wherein the power bank has a capacity of at least approximately 10,000 mAh.

11. The wireless charging pillow of claim 1, wherein the wireless charging pad is configured to charge a mobile phone or a tablet computer.

12. The wireless charging pillow of claim 1, wherein the wireless charging pad protrudes above a surface of the pillow body.

13. The wireless charging pillow of claim 1, wherein the wireless charging pad protrudes above a surface of the pillow body by approximately 5 millimeters.

14. The wireless charging pillow of claim 1, wherein the wireless charging pad is flush with a surface of the pillow body.

15. The wireless charging pillow of claim 1, wherein the wireless charging pad is Qi2-compatible.

16. The wireless charging pillow of claim 1, wherein the wireless charging pad is MagSafe-compatible.

17. The wireless charging pillow of claim 1, wherein the electrical connection between the wireless charging pad and the power bank is a USB-C cable.

18. The wireless charging pillow of claim 1, wherein the pillow body is sized and shaped for use on a sofa.

19. The wireless charging pillow of claim 1, wherein a color of the wireless charging pad is different from a color of the surface of the pillow body.

20. A method of providing a wireless charging pillow, comprising:
providing a pillow body;
providing a wireless charging pad located at a surface of the pillow body;
providing a power bank located within the pillow body; and
providing an electrical connection between the wireless charging pad and the power bank.
